(19) United States
(12) Patent Application Publication
(10) Pub. No.: US 2025/0130958 A1
(43) Pub. Date: Apr. 24, 2025

(54) Root-Trusted Guest Memory Page Management

(71) Applicant: Advanced Micro Devices, Inc., Santa Clara, CA (US)

(72) Inventors: Reshma Lal, Vancouver, WA (US); David A. Kaplan, Austin, TX (US); Jelena Ilic, Austin, TX (US)

(73) Assignee: Advanced Micro Devices, Inc., Santa Clara, CA (US)

(21) Appl. No.: 18/926,087

(22) Filed: Oct. 24, 2024

Related U.S. Application Data
(60) Provisional application No. 63/592,916, filed on Oct. 24, 2023.

(51) Int. Cl. G06F 12/14; G06F 12/1009

(52) U.S. Cl. CPC G06F 12/1475; G06F 12/1009; G06F 12/1483

(57) ABSTRACT

Root-trusted guest memory page management is described. A root-trusted guest is loaded by a hardware platform and authenticated. The root-trusted guest is configured to manage memory operations of different guests via special privileges that permit the root-trusted guest to execute memory operations using a guest's private memory page. To do so, a guest page table includes a novel “T-bit” in each entry, which indicates whether the root-trusted guest or a different guest owns the associated memory page. Each entry in the guest page table for the root-trusted guest additionally includes a “C-bit” that indicates whether the corresponding memory page is a protected page. Combined C-bit and T-bit values for a page table entry dictate whether operations performed as part of handling a guest's memory request are offloaded from the hardware platform to the root-trusted guest.

### PRIORITY

This application claims priority to U.S. Provisional Patent Application No. 63/592,916, filed Oct. 24, 2023, the disclosure of which is hereby incorporated by reference in its entirety.

### BACKGROUND

Computing systems often share data resources, such as in system architectures where different virtual machines access data stored in computing system memory. To maintain computing system integrity, private memory pages for a guest virtual machine are protected via access control by a designated computing system compute unit, such as a security processor. This access control prevents different virtual machines, other than the guest virtual machine, from reading from or writing into the private memory of the guest virtual machine. Such access control, however, presents challenges, as the designated compute unit that performs access control is resource-constrained, resulting in performance and scalability limits for the computing system.

### BRIEF DESCRIPTION OF THE DRAWINGS

FIG. 1 is a block diagram of a non-limiting example system having a hardware platform that is operable to enable memory page management, for computing system guests, by a root-trusted guest using techniques described herein.

FIG. 2 is a block diagram of a non-limiting example system showing the hardware platform of FIG. 1 in greater detail where a root-trusted guest accesses a guest's private memory page to perform at least one operation.

FIG. 3 is a block diagram of a non-limiting example system showing the hardware platform of FIG. 1 in greater detail where a security processor performs an access control check for a memory page request from a root-trusted guest.

FIG. 4 is a block diagram of a non-limiting example procedure describing performance of selectively performing access control checks at a security processor based on a memory page request from a root-trusted guest.

FIG. 5 is a block diagram of a non-limiting example procedure describing creating page table entries for computing system guests, where the page table entries define what system entity performs access control for a guest memory page request.

### DETAILED DESCRIPTION

In computing system architectures where different virtual machines access data stored in system memory, private memory pages for a guest virtual machine are protected via access control by a designated computing system compute unit, such as a security processor. Security processor access control prevents unauthorized virtual machines from reading from or writing into the private memory of the guest virtual machine. In implementations, access control is performed using a reverse mapping table, where the security processor compares an identifier for a guest virtual machine requesting access to a memory page against a table of values that correlate virtual machine identifiers with respective private memory pages the virtual machine is authorized to access.

Such access control, however, presents challenges, as the designated compute unit that performs access control is resource-constrained, resulting in performance and scalability limits for the computing system. For example, a compute unit (e.g., a security processor) tasked with access control has reduced compute resources (e.g., relative to a central processing unit), slower access to memory, reduced processing power, and so forth, which creates a bottleneck that prevents computing systems from instantiating additional virtual machines without significantly hindering system latency. Accordingly, conventional access control techniques limit a number of virtual machines that can be supported by a given computing system.

To address these conventional shortcomings, root-trusted guest memory page management is described. In implementations, a root-trusted guest, such as a root framework-secure virtual machine is loaded by a computing system hardware platform and authenticated as a trustworthy entity. For instance, a computing system virtual machine manager (e.g., a hypervisor) causes the root-trusted guest to generate a guest attestation report that includes information such as an authoring entity (e.g., a developer) associated with the root-trusted guest, a security version number of the root-trusted guest, and a cryptographic measurement of the root-trusted guest's memory pages. For instance, the virtual machine manager generates a hash that represents a cryptographic measurement of private memory pages loaded from the root-trusted guest. The security version number and the authoring entity associated with the root-trusted guest are then used to obtain a security certificate provided by the authoring entity of the root-trusted guest.

The hash representing the cryptographic measurement of the root-trusted guest's private memory pages are compared against the security certificate. In response to the cryptographic hash measurement matching the security certificate, such a match means that the root-trusted guest is secure and trustworthy (e.g., that binary code of the root-trusted guest is exactly as released by the authoring entity). Alternatively, if the cryptographic hash measurement does not match the security certificate, such a discrepancy is evidence of interference (e.g., malicious tampering with binary code of the root-trusted guest) and indicates that the root-trusted guest cannot be trusted (e.g., that the virtual machine is regarded by the computing system as a “guest” instead of a “root-trusted guest”).

In response to authenticating a root-trusted guest loaded onto a computing system, the root-trusted guest is assigned a unique identifier (e.g., an address-space identifier (ASID)). Other unique identifiers include a cryptographic token, virtual machine identifier, and so forth. The unique identifier assigned to the root-trusted guest is unique in that it is assignable to only a single root-trusted guest and is immutable (e.g., persists for as long as the root-trusted guest is loaded onto the computing system). Upon loading the root-trusted guest onto the computing system, a designated security compute unit (e.g., a security processor) logs the unique identifier assigned to the root-trusted guest by writing the unique identifier into an isolated region of computing system memory. The isolated memory region in which the unique identifier is logged is accessible by host components of the computing system (e.g., central processing units of the computing system) and is inaccessible to computing system software and computing system guests (e.g., virtual machines loaded onto the computing system, a virtual machine monitor of the computing system, etc.) other than the root-trusted guest having the logged unique identifier.

While a guest is running (e.g., executing one or more operations as part of performing a computational task) and issues a request to access computing system resources (e.g., requests to access data stored in computing system memory), a security processor compares the guest's unique identifier with the unique identifier stored in the isolated memory region. In response to the requesting guest having a unique identifier that matches the unique identifier stored in the isolated memory region, the security processor permits the request to proceed. For instance, in an example scenario where the isolated memory region stores a single unique identifier that represents a root-trusted guest, only requests from the root-trusted guest are granted while requests from other guests are denied.

To alleviate the performance shortcomings facing conventional systems, the described techniques enable a root-trusted guest to manage memory operations of different computing system guests (e.g., grant requests from other guests loaded onto the computing system). To do so, the computing system grants special privileges to the root-trusted guest that permit the root-trusted guest to execute memory operations using a guest's private memory page (e.g., read from and write to a target guest page for a target guest). In implementations, the target guest page represents a data structure maintained in memory of the computing system that is associated with a unique identifier for the target guest (e.g., a unique identifier that is different from the unique identifier representing the root-trusted guest).

In order to maintain a security integrity of private memory pages associated with different guests, the computing system is configured to employ a different encryption scheme for encrypting each guest's private memory pages. As described herein, an encryption scheme collectively refers to the combination of an encryption algorithm and an encryption key. Thus, the computing system is configured to protect a guest's private memory pages by using at least one of an encryption algorithm or an encryption key that is not used to encrypt private memory pages of a different guest. For instance, the computing system encrypts a root-trusted guest's private memory pages using an encryption algorithm and an encryption key, and encrypts a different guest's private memory pages using the same encryption algorithm and a different encryption key.

In some implementations, the computing system uses a common encryption algorithm to encrypt different guests' private memory pages and uses a different encryption key for each guest. In these implementations, the computing system uses the unique identifier that is assigned to a respective guest to identify an encryption key associated with the respective guest (e.g., the computing system maintains a table of encryption key identifiers that are indexed by guests' unique identifiers). Due to the different encryption schemes protecting different guests' private memory pages, a request from a root-trusted guest, identified by the root-trusted guest's unique identifier, to access a target guest's private memory page would fail in conventional systems because an access control unit would identify the incorrect encryption scheme to decrypt the target guest's private memory page. For instance, an access control unit of the computing system would identify the root-trusted guest's unique identifier as corresponding to a first encryption scheme and attempt to use the first encryption scheme to decrypt the target guest's private memory page, while the target guest's private memory page is protected using a second (e.g., different) encryption scheme. To avoid failure of such memory requests by the root-trusted guest on behalf of a target guest, the described techniques enable the root-trusted guest to adopt the target guest's unique identifier when communicating a memory request to the computing system. By enabling the root-trusted guest to adopt the target guest's unique identifier when requesting access to a target guest memory page, the target guest's unique identifier is useable (e.g., by a security processor of the computing system) to identify the appropriate encryption scheme for the target guest memory page.

In implementations where a guest is requesting to access a page in memory of the computing system onto which the guest is loaded, the guest does not know a physical address for the memory page. Rather, the guest only knows a “guest virtual address” for the requested memory page. The guest then queries a guest page table that correlates the guest virtual address with a guest physical address. In implementations, the guest virtual address is translated to its guest physical address by walking through the guest page table. The computing system maintains a separate nested page table that is useable to translate a guest physical address to a system physical address for a memory page, such that the requested memory page can be accurately identified and located in memory of the computing system.

By maintaining a guest's “guest page table” separately from the “nested page table,” the computing system ensures that the system physical address for a memory page remains unknown to a guest. The computing system further maintains a reverse mapping (“RMP”) table as a data structure that is separate from a guest page table and the nested page table. The RMP table stores information describing which guests (e.g., as identified by their respective unique identifiers) are permitted to access individual memory pages (e.g., as identified by their respective system physical addresses).

After performing a nested page table walk to identify the system physical address for a requested memory page, the computing system performs an RMP check using the RMP table to verify whether the guest from which the memory page request was received is permitted to access the system physical address for the memory page. In order to permit the root-trusted guest to service memory requests on behalf of a different guest, the root-trusted guest is configured to maintain a guest page table (e.g., in memory of the computing system) that includes a novel “T-bit” in each entry of the guest page table. The T-bit is a single binary bit that having a value (e.g., a “1” or a “0” that indicates whether a memory page is private to a root-trusted guest or private to a guest other than the root-trusted guest. Setting the T-bit entry for a target guest page to a defined value (e.g., “1”) communicates to the computing system that the target guest page is a private page for a guest other than the root-trusted guest.

Because the root-trusted guest itself is unable to map a guest physical address to a system physical address for a memory page, the computing system updates the root-trusted guest's guest page table to include the system physical address for a target guest's memory page (e.g., replaces the guest physical address in the root-trusted guest's guest page table for the target memory page with the appropriate system physical address) when the T-bit entry for the target memory page equals one. In this manner, the root-trusted guest is able to map a guest virtual address for a request involving the target memory page to the appropriate system physical address, and handle the request using the system physical address in place of the guest physical address.

Each entry in the guest page table for the root-trusted guest additionally includes a “C-bit” (e.g., a cyphertext protection bit) that conveys to the computing system whether the corresponding memory page is a protected page (e.g., is a private memory page for a guest that is protected by an encryption scheme for the guest). For instance, a C-bit value of one indicates that the corresponding memory page is a guest's private memory page, while a C-bit value of zero indicates that the corresponding memory page is a shared memory page. For a memory request involving a memory page having an entry in the guest page table of the root-trusted guest with a T-bit value equal to one and a C-bit value equal to one, the computing system's page table walker (e.g., compute unit) abstains from performing a nested page table walk. Stated differently, T-bit and C-bit values that are both equal to one for a root-trusted guest's guest page table entry indicates that the output of the root-trusted guest mapping a guest virtual address for a target guest memory page to a guest physical address will return the correct system physical address for the target guest memory page.

Advantageously, this reduces computational resources otherwise consumed by the computing system during the nested page table walk (e.g., setting the T-bit and C-bit values to one causes a page table walker of the computing system to skip the nested page table walk). By inserting a system physical address for a target guest's memory page into the guest page table of the root trusted guest, the described techniques advantageously permit the root-trusted guest to access and/or modify the target guest's private memory page (e.g., read from, write to, move the private memory page to a different location, and so forth), which is not enabled by conventional systems. The described techniques further offload performance of an RMP check to the root-trusted guest, which is permitted to access the RMP table to identify an appropriate encryption scheme for decrypting the target guest's private memory page. For instance, storage of the root-trusted guest's unique identifier in an isolated memory region permits the root-trusted guest to access the RMP table that indicates whether a target guest for which a memory request is being handled (e.g., by the root-trusted guest) is permitted to access the system physical address at which a requested memory page is stored. In this manner, the techniques described herein enable hardware platforms to realize technical advantages not afforded by conventional system architectures (e.g., decreased power consumption, decreased latency, additional bandwidth, and so forth).

In some aspects, the techniques described herein relate to a system including a hardware platform including physical computer hardware, the physical computer hardware including at least one compute unit and at least one memory, a virtual machine monitor configured to virtualize the physical computer hardware of the hardware platform to instantiate a plurality of framework-secure virtual machines, and a root framework-secure virtual machine instantiated by the virtual machine monitor, the root framework-secure virtual machine configured to control access to the at least one memory by the plurality of framework-secure virtual machines.

In some aspects, the techniques described herein relate to a system, wherein the at least one memory includes a guest page table that includes a plurality of entries, each of the plurality of entries corresponding to at least one memory page loaded by the root framework-secure virtual machine or one of the plurality of framework-secure virtual machines.

In some aspects, the techniques described herein relate to a system, wherein each of the plurality of entries include a C-bit having a value that indicates whether a memory page is shared, or private to the root framework-secure virtual machine or one of the plurality of framework-secure virtual machines.

In some aspects, the techniques described herein relate to a system, wherein each of the plurality of entries include a T-bit having a value that indicates whether a memory page is private to the root framework-secure virtual machine, or private to one of the plurality of framework-secure virtual machines.

In some aspects, the techniques described herein relate to a system, wherein each of the plurality of entries in the guest page table include a mapping of a guest virtual address to a guest physical address for the memory page, wherein the at least one compute unit uses the guest physical address for the memory page as a system physical address for the memory page based on the T-bit indicating that the memory page is private to one of the plurality of framework-secure virtual machines.

In some aspects, the techniques described herein relate to a system, wherein the at least one memory includes a nested page table that includes a plurality of entries, each of the plurality of entries mapping a guest physical address to a system physical address for a memory page.

In some aspects, the techniques described herein relate to a system, wherein the at least one compute unit walks the nested page table to identify the system physical address for the memory page in response to a request from the root framework-secure virtual machine to access the memory page, wherein the memory page is a private memory page of the root framework-secure virtual machine.

In some aspects, the techniques described herein relate to a system, wherein the at least one compute unit does not walk the nested page table to identify the system physical address for the memory page in response to a request from the root framework-secure virtual machine to access the memory page, wherein the memory page is a private memory page of one of the plurality of framework-secure virtual machines. In some aspects, the techniques described herein relate to a system, wherein

the request from the root framework-secure virtual machine includes a request from the virtual machine monitor to manage the memory page on behalf of the one of the plurality of framework-secure virtual machines.

In some aspects, the techniques described herein relate to a system, wherein the at least one memory includes a reverse mapping table that includes a plurality of entries, each of the plurality of entries including a system physical address and at least one identifier of a guest permitted to access the system physical address, wherein the guest is the root framework-secure virtual machine or one of the plurality of framework-secure virtual machines.

In some aspects, the techniques described herein relate to a system, wherein the at least one compute unit is configured to verify, using the reverse mapping table, that the root framework-secure virtual machine is permitted to access a system physical address of the at least one memory that stores a memory page in response to a request from the root framework-secure virtual machine to access the memory page, wherein the memory page is a private memory page of the root framework-secure virtual machine.

In some aspects, the techniques described herein relate to a system, wherein the root framework-secure virtual machine is configured to verify, using the reverse mapping table, that one of the plurality of framework-secure virtual machines is permitted to access a system physical address of the at least one memory that stores a memory page in response to a request from the one of the plurality of framework-secure virtual machines to access the memory page, wherein the memory page is a private memory page of the one of the plurality of framework-secure virtual machines.

In some aspects, the techniques described herein relate to a system, wherein the root framework-secure virtual machine is configured to execute at least one command, on behalf of the plurality of framework-secure virtual machines, that involves access to a memory page that is private to at least one of the plurality of framework-secure virtual machines.

In some aspects, the techniques described herein relate to a system including physical computer hardware including at least one compute unit, and a memory storing a guest page table and a nested page table, a virtual machine monitor configured to virtualize the physical computer hardware and instantiate a root framework-secure virtual machine and at least one framework-secure virtual machine, and the system configured to service a request to access a page in the memory by walking the nested page table using the at least one compute unit responsive to the page in the memory being a private memory page of the root framework-secure virtual machine, or not walking the nested page table responsive to the page in the memory being a private memory page of the at least one framework-secure virtual machine.

In some aspects, the techniques described herein relate to a system, wherein the guest page table includes a plurality of entries, each of the plurality of entries including a C-bit having a value that indicates whether a memory page is shared, or private to the root framework-secure virtual machine or the at least one framework-secure virtual machine.

In some aspects, the techniques described herein relate to a system, wherein the guest page table includes a plurality of entries, each of the plurality of entries including a T-bit having a value that indicates whether a memory page is private to the root framework-secure virtual machine, or private to the at least one framework-secure virtual machine.

In some aspects, the techniques described herein relate to a system, wherein the system is configured to identify that the page in the memory is the private memory page of the root framework-secure virtual machine responsive to the value of the T-bit being zero.

In some aspects, the techniques described herein relate to a system, wherein the system is configured to identify that the page in the memory is the private memory page of the at least one framework-secure virtual machine responsive to the value of the T-bit being one.

In some aspects, the techniques described herein relate to a system, the memory further storing a reverse mapping table, wherein the system is further configured to service the request to access the page in the memory by the at least one compute unit performing a reverse mapping check using the reverse mapping table responsive to the page in the memory being the private memory page of the root framework-secure virtual machine, or the root framework-secure virtual machine performing the reverse mapping check using the reverse mapping table responsive to the page in the memory being a private memory page of the at least one framework-secure virtual machine.

In some aspects, the techniques described herein relate to a method including receiving, by a hardware platform including physical computer hardware, a request to access a memory page from a root framework-secure virtual machine loaded onto the hardware platform, and granting the request to access the memory page by responsive to the memory page being a private memory page of the root framework-secure virtual machine, walking a nested page table to identify a system physical address for the memory page and performing a reverse mapping table check using at least one compute unit of the physical computer hardware, or responsive to the memory page being a private memory page of a framework-secure virtual machine other than the root framework-secure virtual machine, performing the reverse mapping table check using the root framework-secure virtual machine independent of walking the nested page table.

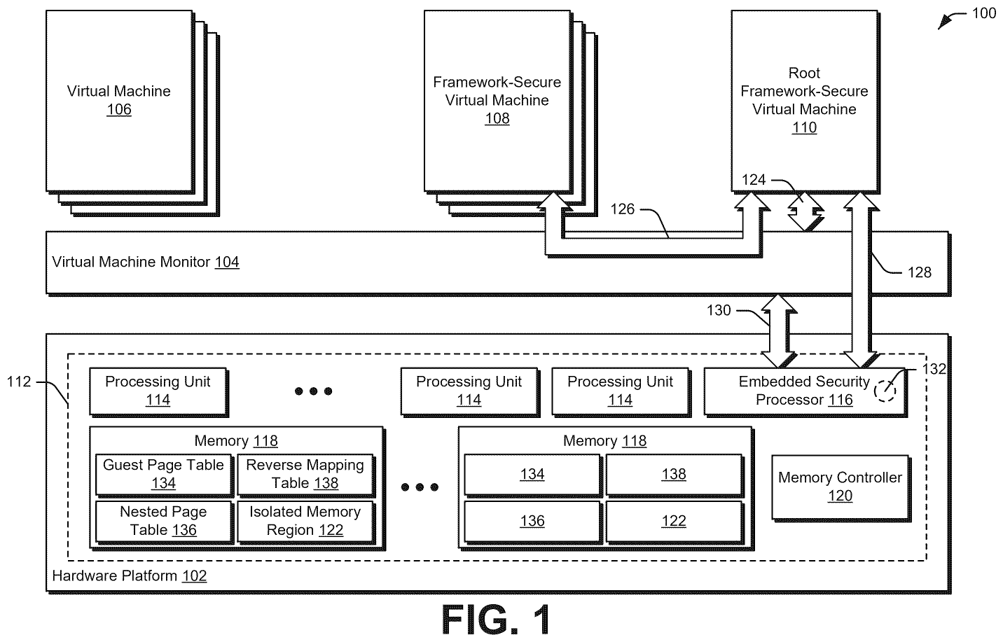

FIG. 1 is a block diagram of a non-limiting example system 100 having a hardware platform that is operable to enable memory page management, for computing system guests, by a root-trusted guest using techniques described herein. In this example, the system 100 includes hardware platform 102 as well as virtual machine monitor 104, one or more virtual machines 106, one or more framework-secure virtual machines 108, and root framework-secure virtual machine 110, which are run on the hardware platform 102.

In this example, the hardware platform 102 is depicted including data fabric 112, one or more processing units 114, embedded security processor 116, one or more memories 118, and memory controller 120. Thus, in accordance with the described techniques, one or more of the virtual machine monitor 104, a virtual machine 106, a framework-secure virtual machine 108, and/or a root framework-secure virtual machine 110 operate by utilizing one or more of the underlying resources of the hardware platform 102 (e.g., one or more of the data fabric 112, a processing unit 114, the embedded security processor 116, a memory 118, or the memory controller 120). In one or more implementations, one or more isolated regions of the memory 118 (e.g., isolated memory region 122) are involved when implementing the guest memory page management techniques described herein.

In variations, the hardware platform 102 includes more, fewer, and/or different hardware components without departing from the spirit or scope of the described techniques (e.g., cache, secondary storage, semiconductor intellectual property (IP) core, and so forth). Additionally, throughout the following description various components of the system 100 are referred to in the singular and/or in the plural, such as the hardware platform 102, the above-mentioned components of the hardware platform 102 (e.g., one or more processing units 114), the virtual machine monitor 104, the virtual machine 106, the framework-secure virtual machine 108, and/or the root framework-secure virtual machine 110. In implementations, however, the number of such components used to implement the described techniques varies without departing from the spirit or scope of the described techniques. While use of one, single embedded security processor 116 and one, single root framework-secure virtual machine 110 is discussed throughout, in at least one variation, multiple security processors and/or multiple root framework-secure virtual machines are used to implement the described techniques, such as in connection with multiple hardware platforms (e.g., used at a data center and/or by a web service provider). In accordance with one or more implementations, the root framework-secure virtual machine 110 is configured to run on multiple threads (e.g., multiple threads executed by a processing unit 114), which enables the root framework-secure virtual machine 110 to concurrently perform guest memory page management techniques described herein.

In the illustrated example, the above-described components (e.g., the data fabric 112, the one or more processing units 114, the one or more memories 118, the embedded security processor 116, the memory controller 120, etc.) are depicted as being included in the hardware platform 102. Examples of the hardware platform 102 include, but are not limited to, one or more of a system-on-chip (SoC) or a system-on-package (SoP).

In accordance with the described techniques, one or more of the processing unit 114, the embedded security processor 116, the memory 118, or the memory controller are coupled to one another via one or more of a wired or wireless connection (e.g., implemented using the data fabric 112). Example wired connections include, but are not limited to, memory channels, buses (e.g., a data bus, a system or address bus), interconnects, through silicon vias, traces, and planes. Other example connections include optical connections, fiber optic connections, and/or connections or links based on quantum entanglement.

Examples of devices or apparatuses in which the system 100 is implemented include, but are not limited to, one or more server computers, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer, and other computing devices or systems.

The processing unit 114 is representative of a compute unit of the hardware platform 102, such as an electronic circuit that performs various operations on and/or using data in the memory 118. Examples of the processing unit 114 include, but are not limited to, a central processing unit (CPU), a graphics processing unit (GPU), a field programmable gate array (FPGA), an accelerator, an accelerated processing unit (APU), and a digital signal processor (DSP), to name a few. In at least one variation, the processing units 114 of the hardware platform 102 are all of a same type (e.g., all CPUs, all a same model of CPUs, all GPUs, etc.). Alternatively, the hardware platform 102 includes at least two different types of processing units 114 (e.g., at least one CPU and at least one GPU, two different types of CPUs, combinations thereof, and so forth). In some implementations, although not depicted in the illustrated example of FIG. 1, the processing unit 114 includes registers configured to locally store data at the processing unit 114. In some implementations, the processing unit 114 further includes circuitry dedicated to performing specific functions (e.g., page table walker circuitry dedicated to walking a nested page table as described in further detail below).

The memory 118 is a device or system that is used to store information, such as for immediate use in a device by the processing unit 114 or by an in-memory processor (not depicted in FIG. 1), which is referred to as a processing-in-memory component or PIM component. In one or more implementations, the memory 118 corresponds to semiconductor memory where data is stored within memory cells on one or more integrated circuits. In at least one example, the memory 118 corresponds to or includes volatile memory, examples of which include random-access memory (RAM), dynamic random-access memory (DRAM), synchronous dynamic random-access memory (SDRAM), static random-access memory (SRAM), and memristors.

The memory 118 is packaged or configured in any of a variety of different manners. Examples of such packaging or configuring include a dual in-line memory module (DIMM), a small outline DIMM (SO-DIMM), a registered DIMM (RDIMM), a non-volatile DIMM (NVDIMM), a ball grid array (BGA) memory permanently attached to (e.g., soldered to, mounted to, etc.) the hardware platform 102 (or other printed circuit board), combinations thereof, and so forth.

Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the memory 118 is configured as or includes a SO-DIMM or an RDIMM according to one of the above-mentioned standards (e.g., DDR, DDR2, DDR3, DDR4, and DDR5).

Alternatively or in addition, the memory 118 corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto resistive random-access memory (MRAM). The memory 118 is configurable in a variety of ways capable of supporting thermal management using an adjustable thermal management algorithm and/or receiving power managed using such an adjustable algorithm.

Further examples of memory configurations include low-power double data rate (LPDDR), also known as LPDDR SDRAM, which is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5). It is to be appreciated that the memory 118 is configurable in a variety of ways without departing from the spirit or scope of the described techniques.

In at least one variation, the memories 118 of the hardware platform 102 are all of a same type (e.g., all DRAMs, all a same model of DRAMs, all MRAM, etc.). Alternatively, the hardware platform 102 includes at least two different types of processing units 114 (e.g., at least one DRAM and a cache system, two different types of DRAM, combinations thereof, and so forth).

The memory controller 120 is a hardware component or subsystem that manages the flow of data to and from the memory 118. By way of example, the memory controller 120 includes logic to read and write to the memory 118 and interface with the processing unit 114. In one or more implementations, the memory controller 120 also includes logic to read and write to various levels of a cache hierarchy (not shown). For instance, the memory controller 120 receives instructions from the processing unit 114, which involve accessing the memory 118, and the memory controller 120 provides data from the memory 118 to the processing unit 114 (e.g., for processing by the processing unit 114). In one or more implementations, the memory controller 120 is communicatively and/or topologically located between the processing unit 114 and the memory 118, and the memory controller 120 interfaces with both the processing unit 114 and the memory 118.

The virtual machine monitor 104 is a software and/or hardware component that virtualizes the physical computer hardware of the hardware platform 102. The virtual machine monitor 104 allocates and manages physical resources of the hardware platform 102 to run one or more virtualized instances of a computer (i.e., virtual machines) on the hardware platform 102. The underlying computing device(s) (e.g., the hardware platform 102) utilized by a virtual machine monitor to instantiate virtual machines is often referred to as a “host.” In contrast, an individual virtual machine instantiated using the hardware platform 102 is often referred to as a “guest.” In the context of the system 100, the virtual machine monitor 104 allocates and manages physical resources of the hardware platform 102, such as the processing unit 114, the embedded security processor 116, the memory 118, and/or the memory controller 120 to instantiate and/or manage one or more virtual machines. A virtual machine monitor is also referred to as a “hypervisor,” examples of which are a Type 1 Hypervisor (e.g., a bare-metal hypervisor) and a Type-2 Hypervisor (e.g., a hosted hypervisor).

In one or more implementations, a “virtual machine” is the virtualization or emulation of a computer system to provide the functionality of the physical computer system. In variations, virtual systems are the virtualization or emulation of computer systems having a range of functionality, for instance, from providing a substitute of a real machine (e.g., being instantiated with the resources used to execute an entire operating system) to executing a computer program in a platform independent manner. In implementations, the capabilities of virtual machines and/or of different virtual machines differs without departing from the spirit or scope of the described techniques.

In accordance with the described techniques, each of the one or more virtual machines 106, the one or more framework-secure virtual machines 108, and the root framework-secure virtual machine 110 is a “virtual machine.”

However, the one or more virtual machines 106, the one or more framework-secure virtual machines 108, and the root framework-secure virtual machine 110 represent instantiations having different characteristics (e.g., deployed in accordance with a security framework) and/or having different functionalities (e.g., managing deployment of the security framework). In one or more implementations, the one or more virtual machines 106 are instantiated by the virtual machine monitor 104 using the underlying resources of the hardware platform 102, but security of the one or more virtual machines 106 is not managed according to a particular security framework.

One example of the security framework is Secure Encrypted Virtualization-Secure Nested Paging (SEV-SNP). The SEV-SNP framework builds upon SEV and SEV-ES (Encrypted State) functionality while adding new hardware-based security protections. For instance, SEV-SNP adds strong memory integrity protection to prevent malicious hypervisor-based attacks like data replay, memory re-mapping, and more in order to create an isolated execution environment. SEV-SNP also introduces several additional optional security enhancements designed to support additional virtual machine use models stronger protection around interrupt behavior, and offers increases protection against side channel attacks, to name a few enhancements. In implementations, the particular security framework differs from SEV-SNP without departing from the described techniques.

In contrast to the one or more virtual machines 106, which are not instantiated or otherwise managed according to the particular security framework (e.g., SEV-SNP), the one or more framework-secure virtual machines 108 and the root framework-secure virtual machine 110 are implemented in accordance with the particular security technique. Further, the root framework-secure virtual machine 110 differs from the one or more framework-secure virtual machines 108 insofar as the root framework-secure virtual machine 110 is configured with elevated permissions (e.g., to access one or more portions of the hardware platform 102) and is operable to control various accesses of one or more portions of the hardware platform 102 by the one or more framework-secure virtual machines 108.

In conventional approaches, some security frameworks are implemented using the embedded security processor 116 and/or without the use of a root framework-secure virtual machine 110. By way of example, conventional SEV-SNP approaches perform guest management and trusted input output (I/O)—management of virtual machines within the security framework such as the one or more framework-secure virtual machines 108—using the embedded security processor 116. In one or more variations, though, the embedded security processor 116 is a slower (e.g., significantly slower) processor than the processing unit 114, which in one or more variations is implemented according to a family of complex instruction set computer (CISC) instruction set architectures, such as x86. Compared to a processing unit 114 implemented according to such an instruction set architecture, for instance, the embedded security processor 116 has limited compute and memory resources.

The embedded security processor 116 also has higher latency when accessing system memory (e.g., the memory 118) relative to the processing unit 114, which decreases the throughput of the embedded security processor 116 when the embedded security processor 116 reads and writes into the system memory during management of the one or more framework-secure virtual machines 108 and during other functions. These differences contribute to higher latency in SEV-SNP security services provided by the embedded security processor 116. Moreover, performance (e.g., throughput) and scaling issues are exacerbated as the number of virtual machines deployed (e.g., by the virtual machine monitor 104) increases, such as with a number of core counts of newer platform hardware (e.g., processing units with more cores) and/or as new security features are added to keep up with evolving data center regulations.

In contrast to conventional approaches, the root framework-secure virtual machine 110 is instantiated and works in concert with the embedded security processor 116 and the virtual machine monitor 104 to implement the security framework (e.g., SEV-SNP). Because the root framework-secure virtual machine 110 is allowed to run management of the one or more framework-secure virtual machines 108 and/or trusted input/output (TIO) using the processing unit 114 (e.g., in x86), the described system 100 improves performance (e.g., increased throughput, reduced latency, etc.) of the particular security framework (e.g., SEV-SNP) relative to conventional systems. Moreover, the described system 100 also enables security features of the security framework to be easily scaled, such as to support various protocols including secure compute express link (CXL), graphics processing unit (GPU) support, and so on.

The illustrated example also depicts communication interfaces between various depicted components, including an interface 124, an interface 126, an interface 128, and an interface 130. In one or more implementations, the interface 124, the interface 126, the interface 128, and the interface 130 are at least, in part, activated and/or managed during runtime by the virtual machine monitor 104, which leverages various code of the virtual machine monitor 104 (e.g., hypervisor), and according to the particular security framework (e.g., SEV-SNP). In one or more implementations, the interface 126 and the interface 128 are secured according to the particular security framework (e.g., those interfaces are encrypted), such that the virtual machine monitor 104 cannot access (e.g., “see”) the data being communicated across those interfaces even though the virtual machine monitor 104 facilitates communication of such. In contrast, the interface 124 and the interface 130 are not secured in the same manner, (e.g., interface 124 and interface 130 are not encrypted). In one or more implementations, the interface 124 and the interface 130 are cleartext interfaces.

In one or more implementations, the interface 124 is used for communication of commands of the root framework-secure virtual machine 110 that are available to the virtual machine monitor 104 for management of the one or more framework-secure virtual machines 108. In one or more implementations, the interface 126 is used for communication of messages from the one or more framework-secure virtual machines 108 to the root framework-secure virtual machine 110. In one or more implementations, the interface 128 is used for communication of messages from the root framework-secure virtual machine 110 to the firmware 132 of the embedded security processor 116. In one or more implementations, the interface 130 is used for communication of firmware 132 commands to initialize the security framework and for management (e.g., initialization, runtime management, and shutdown) of the root framework-secure virtual machine 110. The various messages communicated across those interfaces are discussed in more detail below.

The system 100 discussed above and below improves performance of a particular security framework (e.g., SEV-SNP) by moving management of the one or more framework-secure virtual machines 108, trusted I/O, and other security functions from firmware 132 of the embedded security processor 116 into hardware-protected software (e.g., the root framework-secure virtual machine 110) executing on an x86 processor, e.g., the processing unit 114. The described techniques include a set of hardware and firmware mechanisms, and system interfaces (e.g., the interfaces 124-130), to enable the root framework-secure virtual machine 110, a privileged SNP virtual machine, to perform secure virtual machine management. The improvement leverages existing SEV-SNP protections such as reverse mapping table, memory encryption and I/O protections, to protect root framework-secure virtual machine 110's execution and provides special privileges via the processing unit 114 (e.g., CPU) and firmware capabilities described herein.

In one or more implementations, the capabilities of the processing unit 114 and the firmware 132 of the embedded security processor 116 include establishing the run time identity of the root framework-secure virtual machine 110 and locking the identity, allowing the root framework-secure virtual machine 110 to leverage the identity of a framework-secure virtual machine 108 for reading/writing pages of the target framework-secure virtual machine, allowing the root framework-secure virtual machine 110 to read/write into locations of the memory 118 (e.g., the isolated memory region 122) that are not available to any x86 software where examples of those locations include RMP tables and fenced memory regions outside the system memory, performing an atomic update of RMP table entries with bit masking, perform translation lookaside buffer (TLB) flushing for one or more framework-secure virtual machines 108, securely load and update software of the root framework-secure virtual machine 110, and establishing an interface between the root framework-secure virtual machine 110 and the embedded security processor 116.

While root framework-secure virtual machine 110 is identified by its unique identifier (e.g., the root framework-secure virtual machine 110's ASID), similar to the one or more framework-secure virtual machines 108, the security-framework firmware 132 (e.g., implemented by the embedded security processor 116) establishes it as the root framework-secure virtual machine 110 with unique privileges by writing the unique identifier of the root framework-secure virtual machine 110 into a location of the memory 118 that is only accessible to the processing unit 114 (e.g., executing the code to implement the root framework-secure virtual machine 110) and the security-framework firmware 132. This is done only after the security-framework firmware 132 has verified the root framework-secure virtual machine 110's identity by reading an identity block of the root framework-secure virtual machine 110, which is initiated by the root framework-secure virtual machine 110 itself during initialization. Once the unique identifier of the root framework-secure virtual machine 110 is written in the fenced memory location (e.g., isolated memory region 122), only the root framework-secure virtual machine 110 or the embedded security processor 116 can clear its unique identifier at the time the root framework-secure virtual machine 110 is shutdown. The processing unit 114 (e.g., CPU) executing the code to implement the root framework-secure virtual machine 110 checks if the unique identifier of the root framework-secure virtual machine 110 matches the unique identifier of the currently running framework secure virtual machine and grants the currently running machine special privileges only if the unique identifier matches.

When the root framework-secure virtual machine 110 is set to read or write one or more private pages of a target framework-secure virtual machine 108, the processing unit 114 uses the unique identifier of the target framework-secure virtual machine 108 and also uses system physical address (SPA) of the page of the target framework-secure virtual machine 108. The root framework-secure virtual machine 110 provides the unique identifier of the target framework-secure virtual machine 108 to the processing unit 114 via a register, such as via a write to a model-specific register (e.g., a target unique identifier model-specific register (MSR)).

In one or more implementations, the root framework-secure virtual machine 110 tags one or more private memory pages of the target framework-secure virtual machine 108 using a special encoding in a guest page table of the root framework-secure virtual machine 110 (e.g., memory pages loaded by a framework-secure virtual machine 108 to memory 118). This special encoding informs the processing unit 114 which memory page represented by a page table entry corresponds to the target framework-secure virtual machine 108. In the illustrated example of FIG. 1, the guest page table of the root framework-secure virtual machine 110 is stored in memory 118 as the guest page table 134. Individual entries in the guest page table 134 identify one or more pages (e.g., of the memory 118) and include a “C-bit” (e.g., a cyphertext protection bit) that conveys to the computing system whether the corresponding memory page is associated with a guest, such as a framework-secure virtual machine 108 or the root framework-secure virtual machine 110. For instance, a C-bit value of one indicates that the corresponding memory page is a guest's private memory page, while a C-bit value of zero indicates that the corresponding memory page is a shared memory page.

In the illustrated example of FIG. 1, the memory 118 is further depicted as including a nested page table 136. Nested page table 136 is representative of a data structure storing information that maps, for at least one memory page, a guest physical address to a system physical address for the memory page. In implementations where a guest (e.g., a framework-secure virtual machine 108 or the root framework-secure virtual machine 110) is requesting to access a page in memory 118, the guest does not know a physical address for the memory page. Rather, the guest only knows a “guest virtual address” for the requested memory page. The guest then queries a guest page table (e.g., the root framework-secure virtual machine 110 queries the guest page table 134), which correlates the guest virtual address with a guest physical address. In implementations, the guest virtual address is translated to its guest physical address by walking through the guest page table 134. The hardware platform 102 separately maintains the nested page table 136 to translate a guest physical address to a system physical address for a memory page, such that the requested memory page can be accurately identified and located in memory 118.

The root framework-secure virtual machine 110 represents memory pages that belong to a framework-secure virtual machine 108 by causing a new software-visible bit (the “T-bit”) to be set for page table entries corresponding to private pages of the target framework-secure virtual machine 108, such as by setting the T-bit value to one. Conversely, page table entries corresponding to private pages of the root framework-secure virtual machine 110 are assigned a T-bit value of zero. For page table entries in the guest page table 134 having a T-bit of one, the hardware platform 102 (e.g., the processing unit 114 or the embedded security processor 116) treats the guest physical address for the memory page identified by the page table entry to be the same as the system physical address for the memory page.

For a memory request involving a memory page having an entry in the guest page table 134 with a T-bit value equal to one and a C-bit value equal to one, the computing system's page table walker (e.g., the processing unit 114 or the embedded security processor 116) abstains from performing a nested page table walk using nested page table 136. The nested page table walk can be skipped because the processing unit 114 or the embedded security processor 116 has modified the guest physical address for an entry in the guest page table 134 having a T-bit value equal to one. Thus, the root framework-secure virtual machine 110 is able to map a guest virtual address for a target memory page of a framework-secure virtual machine 108 directly to the system physical address for the target memory page using the guest page table 134. Advantageously, this enables the root framework-secure virtual machine 110 to handle a memory request on behalf of the framework-secure virtual machine 108 independent of (e.g., without) walking the nested page table 136.

The computing system further maintains a reverse mapping table 138, which represents a data structure in the memory 118 that is separate from the guest page table 134 and the nested page table 136. The reverse mapping table 138 is representative of data that describes which guests (e.g., one or more framework-secure virtual machines 108 and the root framework-secure virtual machine 110, each represented by their respective unique identifier) are permitted to access pages in the memory 118 (e.g., as represented by their respective system physical addresses). In implementations where the nested page table 136 is walked to identify a system physical address for a memory request (e.g., when the guest page table 134 entry for the requested memory page has a T-bit value of zero), the hardware platform 102 (e.g., the processing unit 114 or the embedded security processor 116) consults the reverse mapping table 138 before permitting the memory request to proceed.

For instance, after walking the nested page table 136 to identify the system physical address for the requested memory page, the hardware platform 102 compares a unique identifier of the guest from which the memory request was received to determine whether the guest is permitted to access the system physical address. If the reverse mapping table 138 indicates that the guest identifier is permitted to access the system physical address, the hardware platform 102 (e.g., via the virtual machine monitor 104) permits the memory request to proceed. Alternatively, if the guest identifier is not permitted to access the system physical address, the memory request is denied.

In implementations where the nested page table 136 walk is skipped (e.g., when a memory request from the root framework-secure virtual machine 110 pertains to a page with a guest page table 134 entry having a T-bit equal to one), the described techniques offload the reverse mapping table 138 check to the root framework-secure virtual machine 110. In implementations, access to the reverse mapping table 138 is controlled by the embedded security processor 116 based on the unique identifier for the root framework-secure virtual machine 110 maintained in the isolated memory region 122 (e.g., the only guest permitted to access the reverse mapping table 138 is the guest having the unique identifier maintained in the isolated memory region 122).

Given access to the reverse mapping table 138, the root framework-secure virtual machine 110 is enabled to perform an RMP check to verify that a framework-secure virtual machine 108 is permitted to access a system physical address at which a memory page is stored (e.g., for a memory request handled by the root framework-secure virtual machine 110 on behalf of the framework-secure virtual machine 108 involving the memory page). In some implementations, the reverse mapping table 138 further includes information identifying the appropriate encryption scheme for decrypting a target guest page in memory 118. As a specific example, after mapping a guest virtual address for a memory page requested by a framework-secure virtual machine 108 to a system physical address using the guest page table 134, the root framework-secure virtual machine 110 checks the reverse mapping table 138 to identify whether a unique identifier for the framework-secure virtual machine 108 is permitted to access the system physical address.

If permitted, and if the memory page at the system physical address is encrypted, the reverse mapping table 138 includes information identifying an encryption scheme used to encrypt the memory page (e.g., an encryption algorithm and an encryption key assigned to the unique identifier of the framework-secure virtual machine 108). The guest page table 134 and the reverse mapping table 138 thus permit the root framework-secure virtual machine 110 to handle memory requests on behalf of one or more framework-secure virtual machines 108 by offloading operations that would otherwise have to be performed by at least one processing unit 114 and/or the embedded security processor 116.

In accordance with the described techniques, existing flows for launching a framework-secure virtual machine 108 are modified to detect the root framework-secure virtual machine 110's identity during the launch process by verifying that the code of the root framework-secure virtual machine 110 is signed and has expected version numbers (e.g., including the security version number (SVN)). In accordance with the particular security framework, the identify of the root framework-secure virtual machine 110 is stored in the firmware 132 of the embedded security processor 116. When the root framework-secure virtual machine 110 is first run by the virtual machine monitor 104 using a utility and/or command (e.g., VMRUN), the root framework-secure virtual machine 110 calls an initialization function in the firmware 132 (e.g., of the embedded security processor 116) which establishes the root framework-secure virtual machine 110's identity for a processing unit 114's use by writing the identity into a location that is accessible to the processing unit 114 and the firmware 132 only. The root framework-secure virtual machine 110 clears memory of the processing unit 114 used to store the unique identifier (e.g., ASID) of the root framework-secure virtual machine 110 when the root framework-secure virtual machine 110 is terminated. The interface 128 between the root framework-secure virtual machine 110 and

the embedded security processor 116 allows the root framework-secure virtual machine 110 to provide the commands via the root framework-secure virtual machine 110's private pages and for the firmware 132 of the embedded security processor 116 to return a response by writing the response directly into a private page of the root framework-secure virtual machine 110 instead of using an existing message based protocol between the one or more framework-secure virtual machines 108 and firmware 132 of the security framework (e.g., on the embedded security processor 116).

In at least one implementation, the modifications to the architecture of system 100 leverages the security framework (e.g., SNP) architecture to host a trusted software-implemented module (e.g., executed code or binary at least one processing unit 114) as a privileged root virtual machine (e.g., root framework-secure virtual machine 110). Further, the root framework-secure virtual machine 110 is protected using hardware security enforcements such as reverse mapping table protection and memory encryption.

In one or more implementations, the root framework-secure virtual machine 110 is signed by an authority, is authenticated and loaded securely by the embedded security processor 116, has strong hardware enforced identity that can be checked by processing unit 114 and the firmware 132 before granting the root framework-secure virtual machine 110 special privileges, has special hardware privileges that allows the root framework-secure virtual machine 110 to perform guest management, trusted I/O and other functions, is in the trusted computing base (TCB) of all framework-secure virtual machines 108 and is included in attestation of framework-secure virtual machines 108.

In one or more implementations, the described system 100 redistributes responsibilities relative to conventional techniques leveraging the security framework to improve scalability and reduce latency, among other improvements. In one or more implementations, for example, the functions of the embedded security processor 116, after redistribution, include initialization and shutdown of the security framework; configuring cores, memory encryption engines, and the input/output (I/O) memory management unit (IOMMU); initializing reverse mapping tables (RMP) and micro-architectural structures; security framework trusted I/O (e.g., SEV-TIO initialization); trusted computing base (TCB) and attestation key management, management of the root framework-secure virtual machine 110, low level hardware functions for guest and trusted input/output (I/O), which is also referred to as “TIO” management, and programming framework secure virtual machine keys in UMC, integrity and data encryption key in RC, and flushing data fabric.

In one or more implementations, the functions of the root framework-secure virtual machine 110, after redistribution, include management of the one or more framework-secure virtual machines 108; launching, activating, and decommissioning the one or more framework-secure virtual machines 108; runtime management (e.g., page swap, move, unsmash, reclaim, etc.); operation as a migration service; handling of security framework trusted I/O (e.g., SEV-TIO handling); trusted execution environment (TEE) device interface security protocol (TDISP) handling (e.g., secure protocol and data model (SPDM), integrity and data encryption key management); TEE device interface (TDI) management; enhancements to the security framework; handling of secure CXL memory/accelerators, scalable I/O virtualization (SIOV) and others; and can act as a device security manager for integrated devices such as DACC.

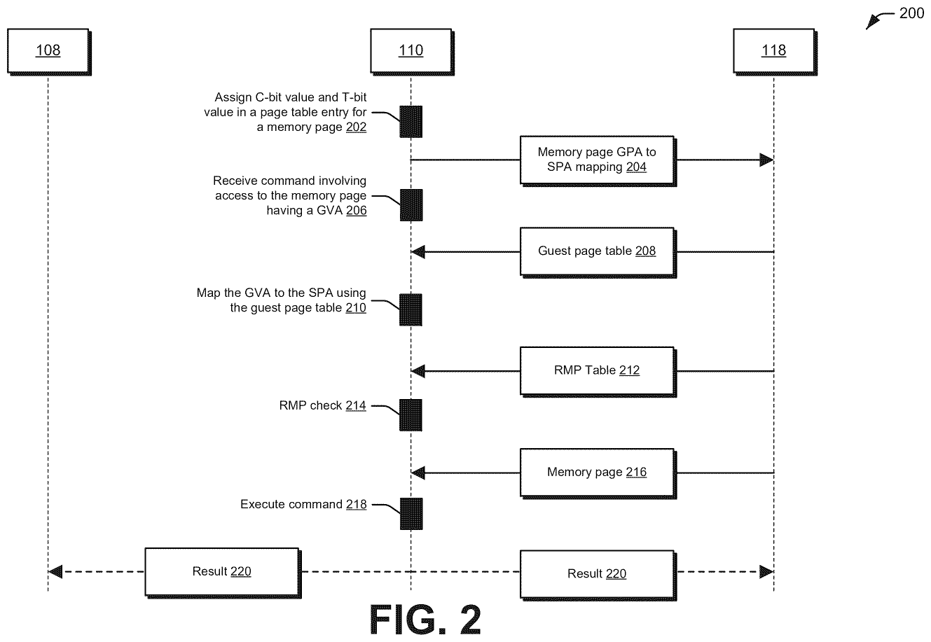

FIG. 2 is a block diagram of a non-limiting example system 200 showing the hardware platform 102 in greater detail where a root-trusted guest accesses a guest's private memory page to perform at least one operation. Specifically, FIG. 2 depicts the framework-secure virtual machine 108 loaded onto the hardware platform 102, the root framework-secure virtual machine 110, and the memory 118 of the hardware platform 102. Upon loading of the framework-secure virtual machine 108, one or more private memory pages loaded from the framework-secure virtual machine 108 are written to one or more physical addresses in the memory 118.

The root framework-secure virtual machine 110 logs each private memory page of the framework-secure virtual machine 108 in the guest page table 134 (e.g., creates an entry in the guest page table 134 for each memory page of the framework-secure virtual machine 108). As part of logging each private page of the framework-secure virtual machine 108, the root framework-secure virtual machine 110 assigns a C-bit value and a T-bit value in the corresponding page table entry of the guest page table 134 (block 202). Specifically, the root framework-secure virtual machine 110 sets the C-bit value to one and sets the T-bit value to one for each page table entry representing a private page of the framework-secure virtual machine 108. In addition to including a C-bit value indicating whether the corresponding memory page is private to a guest (e.g., the framework-secure virtual machine 108 or the root framework-secure virtual machine 110) and a T-bit value indicating whether or not the corresponding memory page is associated with the framework-secure virtual machine 108, each page table entry in the guest page table 134 includes a mapping of the page's guest virtual address to its guest physical address.

The root framework-secure virtual machine 110 identifies the page table entry in the guest page table 134 having a T-bit value equal to one and modifies the page table entry by mapping the memory page's guest virtual address to its guest physical address, which is treated as to the system physical address for the memory page (block 204). In this manner, the root framework-secure virtual machine 110 updates the guest page table 134, such that a guest virtual address for a memory page is mapped directly to its location in memory 118 (e.g., a system physical address for the memory page).

The root framework-secure virtual machine 110 then receives a request to execute at least one command involving access to a memory page identified by a guest virtual address (block 206). The root framework-secure virtual machine 110, for instance, receives a request from the virtual machine monitor 104 via interface 124 to execute one or more commands and/or operations as part of performing a computational task using data stored in memory 118 (e.g., data that is private to a framework-secure virtual machine 108), such as a read from memory 118, a write to memory 118, moving a page in memory 118, combinations thereof, and so forth.

As part of executing one or more commands or operations on behalf of a computing system guest (e.g., the framework-secure virtual machine 108), the root framework-secure virtual machine 110 retrieves its guest page table from memory (block 208). For instance, the root framework-secure virtual machine 110 retrieves the guest page table 134 from memory 118. Using the guest page table, the root framework-secure virtual machine 110 maps the guest virtual address of the target guest memory page (e.g., the guest virtual address specified by the command received at block 206) to a system physical address for the target guest memory page (block 210). Due to the mapping performed at block 204, the root framework-secure virtual machine 110 is configured to map the guest virtual address for the target guest memory page to its system physical address independent of walking the nested page table 136.

The root framework-secure virtual machine 110 then retrieves a reverse mapping table (block 212) to determine whether the framework-secure virtual machine 108, on behalf of which the root framework-secure virtual machine 110 is executing the command received at block 206, is permitted to access the system physical address identified at block 210. The root framework-secure virtual machine 110, for instance, retrieves the reverse mapping table 138 from memory 118 and performs a reverse mapping check (block 214). In implementations, the root framework-secure virtual machine 110 performs a reverse mapping check by comparing an entry in the reverse mapping table 138 for the system physical address identified at block 210 with one or more corresponding unique identifiers that represent guest(s) permitted to access the system physical address in memory 118. In some implementations, the command received at block 206 is further received by the root framework-secure virtual machine 110 with information describing a unique identifier for the framework-secure virtual machine 108. In these implementations, the unique identifier for the framework-secure virtual machine 108 is compared against an entry in the reverse mapping table 138 to identify whether the framework-secure virtual machine 108 is permitted to access the requested target guest memory page.

In response to passing the RMP check (e.g., verifying that the framework-secure virtual machine 108 is authorized to access one or more memory pages associated with the command received at block 206), the root framework-secure virtual machine 110 retrieves the memory page 216 from memory 118. In some implementations, the root framework-secure virtual machine 110 is configured to decrypt the memory page 216 using an encryption scheme that was used to encrypt private memory pages of the framework-secure virtual machine 108. For instance, the root framework-secure virtual machine 110 uses the unique identifier associated with the framework-secure virtual machine 108 to identify an encryption scheme used by the hardware platform 102 to encrypt the memory page 216. In implementations, a data structure that correlates encryption schemes with guest unique identifiers is maintained in memory, such as in the reverse mapping table 138 or in another data storage location accessible by the root framework-secure virtual machine 110.

Upon obtaining an unencrypted version of the memory page 216, the root framework-secure virtual machine 110 executes a command on behalf of the framework-secure virtual machine 108 (block 218). In some implementations, the root framework-secure virtual machine 110 outputs a result 220 generated from executing the command at block 218, as indicated by the dashed arrows in FIG. 2. For instance, in an example implementation where the command is to read one or more values from memory page 216, the root framework-secure virtual machine 110 outputs the one or more values to framework-secure virtual machine 108 as the result 220. Alternatively or additionally, in some implementations the result 220 is output to a destination other than the framework-secure virtual machine 108. For instance, in the result 220 represents a value written to the memory page 216, or another page in the memory 118. Alternatively or additionally, the result 220 represents movement of the memory page 216 to a different location in the memory 118 and outputting the result 220 comprises updating at least one entry in the guest page table 134 to reflect the page movement. Thus, although an example result 220 is depicted in FIG. 2 as being output to the framework-secure virtual machine 108 and/or the memory 118, the result 220 is representative of any output generated by the root framework-secure virtual machine 110 as part of executing a command on behalf of the framework-secure virtual machine 108, using data stored in a private memory page of the framework-secure virtual machine 108.

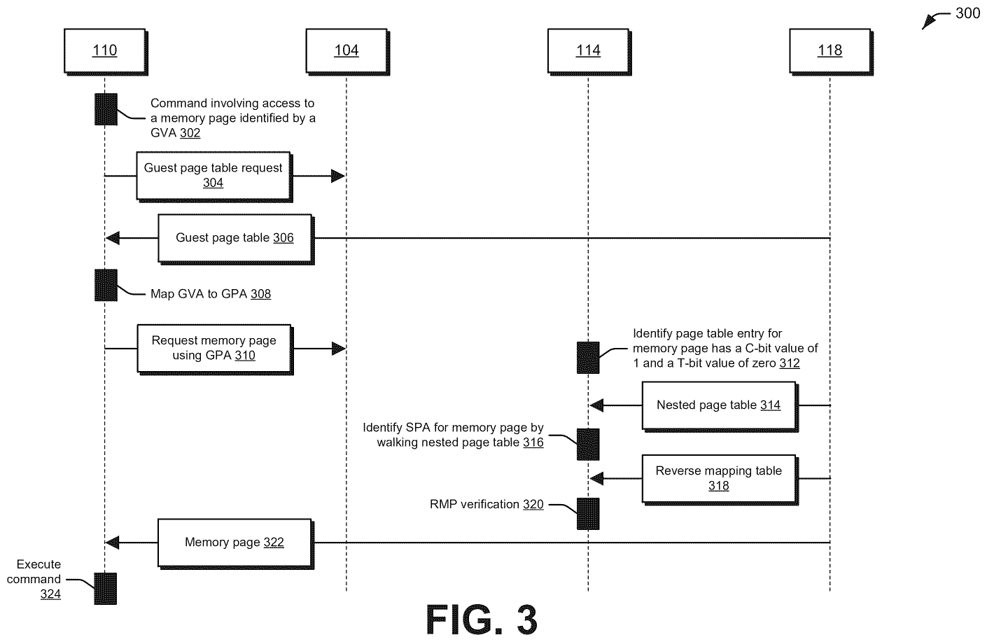

In contrast to the illustrated example of FIG. 2, where the root framework-secure virtual machine 110 identifies a system physical address for a target guest page independent of walking the nested page table 136, consider FIG. 3.

FIG. 3 is a block diagram of a non-limiting example system 300 showing the hardware platform 102 in greater detail where a security processor performs an access control check for a memory page request from a root-trusted guest.

In the illustrated example of FIG. 3, the root framework-secure virtual machine 110 is depicted as executing a command involving access to a memory page identified by a guest virtual address (block 302). The command involving access to the memory page identified by the guest virtual address at block 302, for instance, is representative of a command involving data stored in one or more memory pages that are private to the root framework-secure virtual machine 110.

As part of executing the command, the root framework-secure virtual machine 110 requests its guest page table from the hardware platform 102 via the virtual machine monitor 104 (block 304). The guest page table request causes the guest page table 134 to be returned to the root framework-secure virtual machine 110 from memory 118 (block 306). Using the guest page table 134, the root framework-secure virtual machine 110 maps the guest virtual address for the memory page to its guest physical address (block 308).

The root framework-secure virtual machine 110 then requests the memory page from the hardware platform 102 using the guest physical address (block 310). Based on the request, at least one processing unit 114 identifies that a page table entry in the guest page table 134 including the guest physical address has a C-bit value of one and a T-bit value of zero (block 312). Identifying that the guest physical address has a C-bit value of one and a T-bit value of zero indicates that the requested page is private to the root framework-secure virtual machine 110. Due to the T-bit value being zero, the processing unit 114 identifies that it is necessary to walk the nested page table 136 and retrieves the nested page table 136 from memory 118 (block 314).

The processing unit 114 then identifies the system physical address by walking the nested page table 136 using the guest physical address (block 316). The processing unit 114 then obtains the reverse mapping table 138 (block 318) and performs RMP verification (block 320) to evaluate whether the root framework-secure virtual machine 110 is permitted to access the system physical address that results from the nested page table 136 walk. Unless the root framework-secure virtual machine 110 passes RMP verification for accessing the requested system physical address, the processing unit 114 denies access to the requested memory page. Alternatively, in response to the reverse mapping table 138 indicating that the root framework-secure virtual machine 110 is permitted to access the system physical address, the processing unit 114 grants access and communicates the requested memory page to the root framework-secure virtual machine 110 (block 322). The root framework-secure virtual machine 110 then executes the command using data stored in the memory page (block 324).

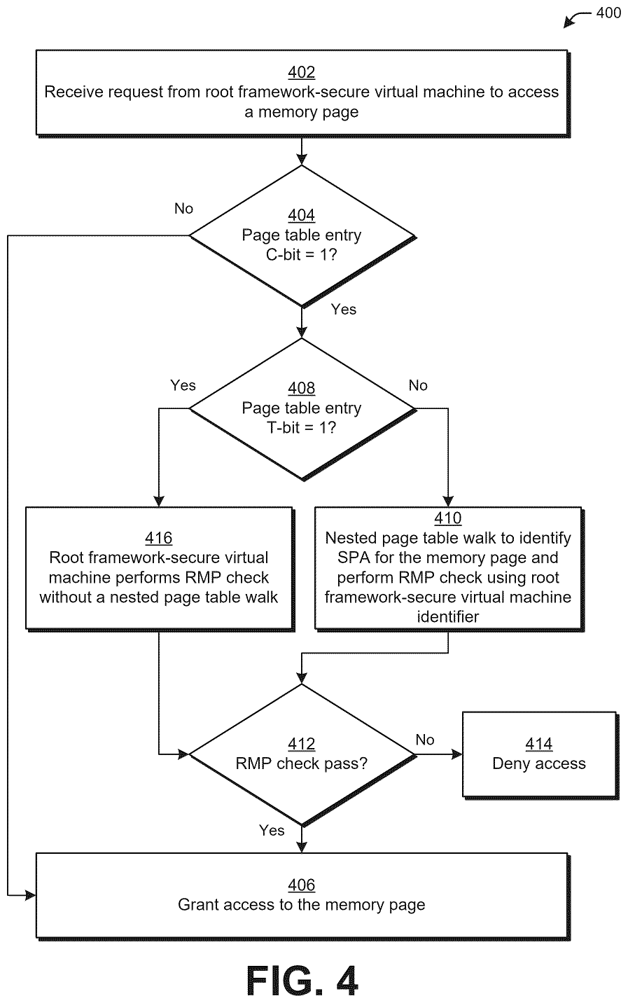

FIG. 4 is a block diagram of a non-limiting example procedure 400 describing performance of selectively performing access control checks at a security processor based on a memory page request from a root-trusted guest.

To begin, a request is received from a root framework-secure virtual machine to access a memory page (block 402). The hardware platform 102, for instance, receives a request from the root framework-secure virtual machine 110, via the virtual machine monitor 104, to access a page in memory 118. In implementations, the request is received with information describing a guest virtual address for the memory page being requested.

Upon receipt of the request, a determination is made as to whether a page table entry for the requested memory page includes a C-bit value equal to one (block 404). The processing unit 114, for instance, identifies a page table entry in the guest page table 134 based on the guest virtual address received as part of the request from the root framework-secure virtual machine 110. In response to identifying that the page table entry includes a C-bit value of zero (e.g., a “No” determination at block 404), the processing unit 114 grants access to the requested memory page (block 406). Identifying a C-bit value of zero in the guest page table 134 indicates that the requested memory page is a shared page that the root framework-secure virtual machine 110 is permitted to access, and the processing unit 114 uses this information to grant the request.

Alternatively, in response to determining that the page table entry includes a C-bit value of one (e.g., a “Yes” determination at block 404), the processing unit 114 evaluates whether the page table entry includes a T-bit value of zero (block 408). The processing unit 114, for instance, identifies a page table entry in the guest page table 134 based on the guest virtual address received as part of the request from the root framework-secure virtual machine 110. In response to identifying that the page table entry includes a T-bit value of zero (e.g., a “No” determination at block 408), a nested page table walk is performed to identify a system physical address for the memory page and a reverse mapping table check is performed to verify that the root framework-secure virtual machine is permitted to access the system physical address (block 410).

The processing unit 114, for instance, identifies that the C-bit value of one and the T-bit value of zero in the page table entry for the requested page indicates that the requested page is a private page of the root framework-secure virtual machine 110. Based on this information, the processing unit 114 identifies that the root framework-secure virtual machine 110 is unaware of the system physical address identifying where the requested page is stored in memory 118 and that the root framework-secure virtual machine 110 request to access the memory page includes a guest physical address for the memory page. The processing unit 114 then walks the nested page table 136 to identify the system physical address that is mapped to the guest physical address in the nested page table 136.

After identifying the system physical address via the nested page table 136 walk, the processing unit 114 performs an RMP check using the reverse mapping table 138 to determine whether the root framework-secure virtual machine 110 (e.g., as represented by its unique identifier) is authorized to access the system physical address in memory 118. Based on the data included in the reverse mapping table 138, a determination is made as to whether the guest requesting access to the memory page (e.g., the root framework-secure virtual machine 110) passes the RMP check (block 412). In response to determining that the requesting guest does not pass the RMP check (e.g., a “No” determination at block 412), the request is denied, and the requesting guest is denied access to the requested memory page (block 414). Alternatively, in response to determining that the requesting guest passes the RMP check (e.g., a “Yes” determination at block 412), operation of the procedure 400 proceeds to block 406 and the requesting guest is granted access to the memory page. For instance, the requested memory page is communicated to the root framework-secure virtual machine 110.

Returning to block 408, in an alternative implementation where the processing unit 114 identifies that the page table entry for the requested memory page includes a T-bit value of one (e.g., a “Yes” determination at block 408), the root framework-secure virtual machine 110 performs the RMP check without a nested page table walk (block 416). The T-bit value of one, combined with the C-bit value of one, in a page table entry indicates that the requested memory page is a private page of the framework-secure virtual machine 108. Thus, the T-bit and C-bit values of one indicate that the root framework-secure virtual machine 110 is requesting access to the memory page on behalf of a framework-secure virtual machine 108. Because setting the T-bit value of one causes the root framework-secure virtual machine 110 to treat the guest physical address for the memory page in the guest page table 134 as the system physical address for the memory page, walking the nested page table 136 is unnecessary and not performed by the hardware platform 102.

The T-bit value of one indicates that the root framework-secure virtual machine 110 is capable of performing the RMP check (e.g., using the reverse mapping table 138 to determine whether the framework-secure virtual machine 108, for which the root framework-secure virtual machine 110 is handing the memory request, is permitted to access the system physical address defining a storage location of the requested memory page). When operation of the procedure 400 proceeds from block 416 to block 412, a determination of whether the RMP check is passed is offloaded to the root framework-secure virtual machine 110, which communicates a result of the RMP check to the virtual machine monitor 104 to either deny access to, or retrieve, the requested memory page on behalf of the framework-secure virtual machine 108.

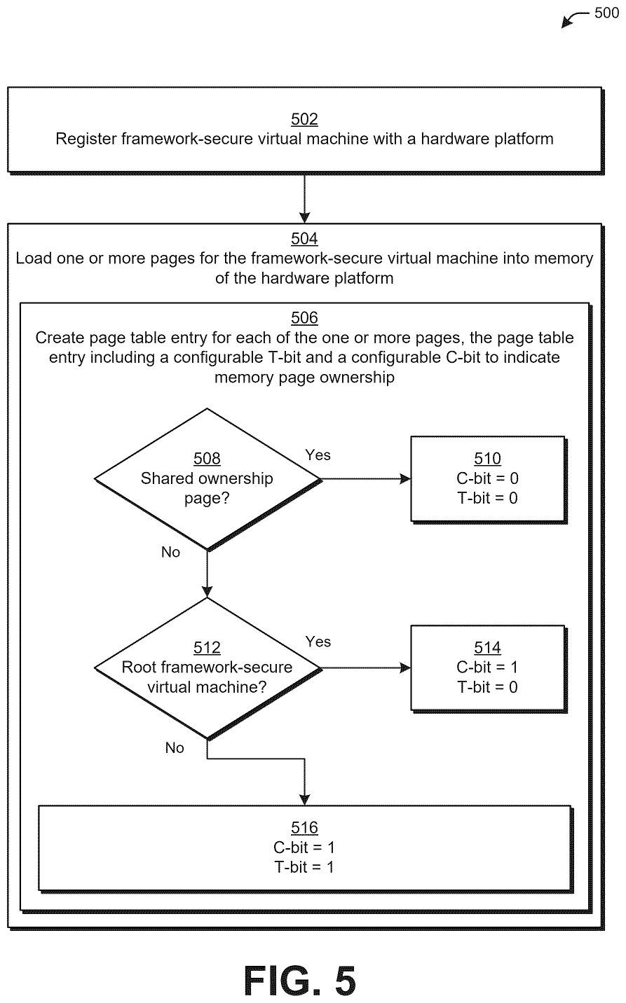

FIG. 5 is a block diagram of a non-limiting example procedure 500 describing creating page table entries for computing system guests, where the page table entries define what system entity performs access control for a guest memory page request.

In the illustrated example of FIG. 5, a framework-secure virtual machine is registered with a hardware platform (block 502). The embedded security processor 116, for instance, registers the root framework-secure virtual machine 110 with the hardware platform 102 and optionally registers at least one framework-secure virtual machine 108 with the hardware platform 102.

One or more pages for the framework-secure virtual machine are loaded into memory of the hardware platform (block 504). For instance, as part of registering with the hardware platform 102, the root framework-secure virtual machine 110 loads at least one page into memory 118 (e.g., via communication with the hardware platform 102 via the interface 124, the interface 128, or a combination thereof). Alternatively or additionally, as part of registering with the hardware platform 102, the framework-secure virtual machine 108 loads at least one page into memory 118 (e.g., by communicating the at least one memory page to the root framework-secure virtual machine 110 via interface 126, which then routes the at least one memory page to the hardware platform 102 via the interface 124, the interface 128, or a combination thereof).

As part of loading the one or more pages of the framework-secure virtual machine into memory of the hardware platform, a page table entry is created for each of the one or more pages, where the page table entry includes a configurable T-bit and a configurable C-bit to indicate memory page ownership (block 506). For instance, a page table entry is created in the guest page table 134 of the root framework-secure virtual machine 110 for each memory page loaded into memory 118 by the root framework-secure virtual machine 110 and/or the framework-secure virtual machine 108.

As part of creating the page table entry for a memory page of a guest loaded onto the hardware platform 102, a determination is made as to whether the memory page is a shared ownership page (block 508). For instance, the processing unit 114 determines whether the memory page identified by the page table entry is private to a system guest (e.g., private to a framework-secure virtual machine 108 or private to the root framework-secure virtual machine 110) or is a shared memory page permitted to be accessed by different entities.

In response to determining that the memory page is a shared memory page (e.g., a “Yes” determination at block 508), the page table entry for the memory page is configured to have a C-bit value of zero and a T-bit value of zero (block 510). Alternatively, in response to determining that the memory page is a private memory page for a system guest (e.g., a “No” determination at block 508), operation of the procedure 500 proceeds to determine whether the memory page is private to a root framework-secure virtual machine (block 512).

The processing unit 114, for instance, compares a unique identifier for a guest from which the memory page identified by the page table entry is received to the unique identifier stored in isolated memory region 122 of the memory 118. Because the unique identifier stored in the isolated memory region 122 identifies the root framework-secure virtual machine 110, in response to detecting that the system guest's unique identifier associated with the memory page being loaded matches the unique identifier stored in the isolated memory region 122, the processing unit 114 identifies that the memory page is private to the root framework-secure virtual machine 110 (e.g., a “Yes” determination at block 512). In response to identifying that the memory page is private to the root framework-secure virtual machine 110, the page table entry for the memory page is configured to have a C-bit value of one and a T-bit value of zero (block 514). This combination of a C-bit value of one and a T-bit value of zero indicates that the memory page associated with the page table entry is private to the root framework-secure virtual machine 110.

Alternatively, in response to identifying that the memory page is a private memory page for a system guest other than the root framework-secure virtual machine 110 (e.g., a “No” determination at block 512), the page table entry for the memory page is configured to have a C-bit value of one and a T-bit value of one (block 516). This combination of a C-bit value of one and a T-bit value of one indicates that the memory page associated with the page table entry is private to a guest other than the root framework-secure virtual machine 110, such as a framework-secure virtual machine 108.

The T-bit value of one causes the root framework-secure virtual machine 110 to treat the guest physical address for the memory page in its page table entry with the system physical address for the memory page in memory 118, thereby enabling the root framework-secure virtual machine 110 to handle memory requests on behalf of a framework-secure virtual machine 108 without the hardware platform 102 walking the nested page table 136. The T-bit value of one further indicates that the RMP check (e.g., using reverse mapping table 138) is to be performed by the root framework-secure virtual machine 110, thus offloading responsibility of the RMP check that would otherwise be performed by a compute unit of the hardware platform 102.

The novel T-bit in a page table entry thus advantageously reduces computational resources otherwise consumed by the computing system during the nested page table walk (e.g., setting the T-bit and C-bit values to one causes a page table walker of the computing system to skip the nested page table walk). By inserting a system physical address for a target guest's memory page into the guest page table of the root trusted guest, the described techniques advantageously permit the root-trusted guest to access and/or modify the target guest's private memory page (e.g., read from, write to, move the private memory page to a different location, and so forth), which is not enabled by conventional systems.

The described techniques further offload performance of an RMP check to the root-trusted guest, which is permitted to access the RMP table to identify an appropriate encryption scheme for decrypting the target guest's private memory page. For instance, storage of the root-trusted guest's unique identifier in an isolated memory region permits the root-trusted guest to access the RMP table that indicates whether a target guest for which a memory request is being handled (e.g., by the root-trusted guest) is permitted to access the system physical address at which a requested memory page is stored. In this manner, the techniques described herein enable hardware platforms to realize technical advantages not afforded by conventional system architectures (e.g., decreased power consumption, decreased latency, additional bandwidth, and so forth).

Various implementations are possible based on the disclosure herein, and the described techniques are not so limited to the specific examples described above. Although features and elements are described above in particular combinations, each feature or element is usable alone without the other features and elements or in various combinations with or without other features and elements.

The various functional units illustrated in the figures and/or described herein (including, where appropriate, the hardware platform 102 having the processing units 114, the embedded security processor 116, the memories 118, and the memory controller 120) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a hardware platform comprising physical computer hardware, the physical computer hardware including at least one compute unit and at least one memory;
a virtual machine monitor configured to virtualize the physical computer hardware of the hardware platform to instantiate a plurality of framework-secure virtual machines; and
a root framework-secure virtual machine instantiated by the virtual machine monitor, the root framework-secure virtual machine configured to control access to the at least one memory by the plurality of framework-secure virtual machines.

2. The system of claim 1, wherein the at least one memory includes a guest page table that includes a plurality of entries, each of the plurality of entries corresponding to at least one memory page loaded by the root framework-secure virtual machine or one of the plurality of framework-secure virtual machines.

3. The system of claim 2, wherein each of the plurality of entries include a C-bit having a value that indicates whether a memory page is:
shared; or
private to the root framework-secure virtual machine or one of the plurality of framework-secure virtual machines.

4. The system of claim 2, wherein each of the plurality of entries include a T-bit having a value that indicates whether a memory page is:
private to the root framework-secure virtual machine; or
private to one of the plurality of framework-secure virtual machines.

5. The system of claim 4, wherein each of the plurality of entries in the guest page table include a mapping of a guest virtual address to a guest physical address for the memory page, wherein the at least one compute unit uses the guest physical address for the memory page as a system physical address for the memory page based on the T-bit indicating that the memory page is private to one of the plurality of framework-secure virtual machines.

6. The system of claim 1, wherein the at least one memory includes a nested page table that includes a plurality of entries, each of the plurality of entries mapping a guest physical address to a system physical address for a memory page.

7. The system of claim 6, wherein the at least one compute unit walks the nested page table to identify the system physical address for the memory page in response to a request from the root framework-secure virtual machine to access the memory page, wherein the memory page is a private memory page of the root framework-secure virtual machine.

8. The system of claim 6, wherein the at least one compute unit does not walk the nested page table to identify the system physical address for the memory page in response to a request from the root framework-secure virtual machine to access the memory page, wherein the memory page is a private memory page of one of the plurality of framework-secure virtual machines.

9. The system of claim 8, wherein the request from the root framework-secure virtual machine comprises a request from the virtual machine monitor to manage the memory page on behalf of the one of the plurality of framework-secure virtual machines.

10. The system of claim 1, wherein the at least one memory includes a reverse mapping table that includes a plurality of entries, each of the plurality of entries including a system physical address and at least one identifier of a guest permitted to access the system physical address, wherein the guest is the root framework-secure virtual machine or one of the plurality of framework-secure virtual machines.

11. The system of claim 10, wherein the at least one compute unit is configured to verify, using the reverse mapping table, that the root framework-secure virtual machine is permitted to access a system physical address of the at least one memory that stores a memory page in response to a request from the root framework-secure virtual machine to access the memory page, wherein the memory page is a private memory page of the root framework-secure virtual machine.

12. The system of claim 10, wherein the root framework-secure virtual machine is configured to verify, using the reverse mapping table, that one of the plurality of framework-secure virtual machines is permitted to access a system physical address of the at least one memory that stores a memory page in response to a request from the one of the plurality of framework-secure virtual machines to access the memory page, wherein the memory page is a private memory page of the one of the plurality of framework-secure virtual machines.

13. The system of claim 1, wherein the root framework-secure virtual machine is configured to execute at least one command, on behalf of the plurality of framework-secure virtual machines, that involves access to a memory page that is private to at least one of the plurality of framework-secure virtual machines.

14. A system comprising:
physical computer hardware including:
at least one compute unit; and
a memory storing a guest page table and a nested page table;
a virtual machine monitor configured to virtualize the physical computer hardware and instantiate a root framework-secure virtual machine and at least one framework-secure virtual machine; and
the system configured to service a request to access a page in the memory by:
walking the nested page table using the at least one compute unit responsive to the page in the memory being a private memory page of the root framework-secure virtual machine; or
not walking the nested page table responsive to the page in the memory being a private memory page of the at least one framework-secure virtual machine.

15. The system of claim 14, wherein the guest page table includes a plurality of entries, each of the plurality of entries including a C-bit having a value that indicates whether a memory page is:
shared; or
private to the root framework-secure virtual machine or the at least one framework-secure virtual machine.

16. The system of claim 14, wherein the guest page table includes a plurality of entries, each of the plurality of entries including a T-bit having a value that indicates whether a memory page is:
private to the root framework-secure virtual machine; or
private to the at least one framework-secure virtual machine.

17. The system of claim 16, wherein the system is configured to identify that the page in the memory is the private memory page of the root framework-secure virtual machine responsive to the value of the T-bit being zero.

18. The system of claim 16, wherein the system is configured to identify that the page in the memory is the private memory page of the at least one framework-secure virtual machine responsive to the value of the T-bit being one.

19. The system of claim 16, the memory further storing a reverse mapping table, wherein the system is further configured to service the request to access the page in the memory by:
the at least one compute unit performing a reverse mapping check using the reverse mapping table responsive to the page in the memory being the private memory page of the root framework-secure virtual machine; or
the root framework-secure virtual machine performing the reverse mapping check using the reverse mapping table responsive to the page in the memory being a private memory page of the at least one framework-secure virtual machine.

20. A method comprising:
receiving, by a hardware platform comprising physical computer hardware, a request to access a memory page from a root framework-secure virtual machine loaded onto the hardware platform; and
granting the request to access the memory page by:
responsive to the memory page being a private memory page of the root framework-secure virtual machine, walking a nested page table to identify a system physical address for the memory page and performing a reverse mapping table check using at least one compute unit of the physical computer hardware; or
responsive to the memory page being a private memory page of a framework-secure virtual machine other than the root framework-secure virtual machine, performing the reverse mapping table check using the root framework-secure virtual machine independent of walking the nested page table.
